(19) United States
(12) Patent Application Publication
(10) Pub. No.: US 2002/0069273 A1
(43) Pub. Date: Jun. 6, 2002

(54) System and process for administration of databases

(76) Inventors: Stacy Bryant, Lynchburg, VA (US); Tanya Chowdry, Lynchburg, VA (US)

Correspondence Address: Hunton & Williams, 1900 K Street, N.W., Washington, DC, 20006-1109, US

(21) Appl. No.: 09/727,709

(22) Filed: Dec. 4, 2000

(51) Int. Cl. G06F 15/173

(52) U.S. Cl. 709/223

(57) ABSTRACT

A system and process for performing administrative functions connected with a sales-related database. The process includes the steps of receiving updated information for the sales-related database in a file configured in a predetermined format; saving the updated information to the sales-related database; and uploading the sales-related database to a web-based database using an administrative tool. The process also includes generating reports using the administrative tool.

### BACKGROUND OF THE INVENTION

This invention relates generally to an automated system and process for performing administrative functions for a web-based database. More particularly, the invention relates to the administration of a database or data repository containing information relating to an entity's independent sales agents, brokers, distributors or dealers (hereinafter referred to collectively as “brokers”) and sales made by such brokers.

Many suppliers utilize independent (i.e., non-employee or non-affiliate) brokers to extend their territorial reach or manpower and thereby increase sales of their products and/or services. Such suppliers typically have various requirements, such as training, which a prospective broker must fulfill prior to becoming authorized to sell products/services on behalf of the supplier. Once a broker is authorized to sell the supplier's products/services, it is typical to have a relationship whereby the supplier pays the broker a commission or fee in exchange for a sale of the supplier's products/services. In a situation in which a broker is merely an agent acting on behalf of a principal (the supplier), the principal may have control over the pricing of its products/services to the end customer. In such a situation, the supplier is the party contracting with the end customer, although the broker/agent may complete the required product/service sales contract with the end customer. If a supplier utilizes a large number of independent sales agents or brokers, it is frequently difficult to track information relating to sales made by such brokers and the commissions owed to such brokers by the supplier. Moreover, independent sales agents, not being employees or affiliates of the supplier, are somewhat more likely to terminate their relationships with the supplier in a shorter time period. Thus, frequently suppliers have difficulty tracking the current status of various sales agents/brokers and whether or not they are still selling on behalf of the supplier.

In certain regulated industries, such as the insurance industry, in order for an independent sales agent/broker to market, promote and sell products/services on behalf of the supplier, such sales agent/broker must be licensed to sell insurance products/services in each state or jurisdiction in which such sales agent/broker seeks the ability to sell the supplier's products/services. Such licensure requirements add another level of detail to the information which the supplier must maintain as to such sales agents/brokers.

Frequently, suppliers that utilize a large independent sales force provide periodic reports to each sales agent/broker detailing the sales made by such broker and the commissions payable or paid to such broker. The generation of such reports can be very time-intensive, particularly if the sales information is processed annually. There can be costs associated with such reports for the supplier including man-hours required to collate the data, input data and output data in a desired format, costs for supplies such as paper, and mailing costs to send such reports to the brokers. In many cases, by the time the brokers receive the sales reports, the data is no longer current. While suppliers would like to cut down on the frequency of the sales reports, the brokers typically would like to receive the reports on a more frequent basis. Additionally, in many cases, if the data is inaccurate, there is no quick, easy means to correct such data. Frequently, suppliers incur additional costs associated with lost man-hours when their internal employees must respond to queries from independent brokers about the accuracy of data contained in the sales reports.

The advent of the computer and information databases has altered the manner in which sales data is processed and sales reports are generated. A supplier may now maintain a large volume of sales-related information in one or more databases for later retrieval and use in generating sales reports and the like. Additionally, various databases can be integrated with systems that perform various business operations, such as the supplier's accounting system, the supplier's product/service web site and/or a price/rate/quote engine on the supplier's Internet web site which provides estimated sales prices for the supplier's products/services.

Although such automated information systems and databases have greatly reduced the time it takes a product/service supplier to generate sales and accounting reports and the like, they nevertheless have many deficiencies. Many of the databases and information systems utilized by product/service suppliers have typically lacked an intuitive, user-friendly interface to enable a system/database administrator to make changes to the information stored in such databases. As a result, suppliers may fall behind in updating information and, thus, the data stored in such databases may not be accurate and current. And, although many suppliers have automated various aspects of their sales reporting processes, it is still typical that sales reports for independent brokers/sales agents, must be generated in paper format and mailed to the brokers. As a result, even though the supplier may be making an effort to maintain current and up-to-date information in its databases, because of delays inherent in paper-based sales reports, such reports may be out of date by the time they reach the supplier's brokers.

Thus, there is a need for an easy, user-friendly system and process for administration of sales-related databases, particularly for making modifications to the information stored in such sales-related databases.

### BRIEF SUMMARY OF THE INVENTION

Such deficiencies in prior updating and administrative processes utilized in connection with sales-related databases can be addressed through the system and process of the present invention. In an exemplary embodiment of the invention, the process includes the steps of receiving updated information for the database in a file configured in a predetermined format; saving the configured file containing the updated information to the database; and uploading the database to a web-based database using an administrative tool. The process also includes generating reports using the administrative tool.

### BRIEF DESCRIPTION OF THE DRAWINGS

FIG. 1 is a block diagram illustrating one embodiment of a system for performing administrative functions connected with a sales-related database in accordance with the present invention;

FIG. 2 is a block diagram illustrating one embodiment of a tool for performing administrative functions connected with a sales-related database in accordance with the present invention;

FIG. 3 is a block diagram illustrating a tool for performing administrative functions connected with a sales-related database in accordance with an embodiment of the present invention;

FIG. 4 is a flow diagram illustrating the steps conducted using a tool for performing administrative functions connected with a sales-related database in accordance with one embodiment of the present invention;

FIG. 5 is a flow diagram illustrating the steps conducted in the process for performing administrative functions connected with one or more sales-related databases;

FIG. 6 is a flow diagram illustrating the steps conducted in a process for performing administrative functions connected with a sales-related database in accordance with in one embodiment of the present invention;

FIG. 7 is a detailed flow diagram illustrating the steps conducted in a process for performing administrative functions connected with a sales-related database in accordance with one embodiment of the present invention;

FIG. 8 is an illustrative login screen for the tool for performing administrative functions connected with a sales-related database;

FIG. 9 is an illustrative selection screen for the tool for performing administrative functions connected with one or more sales-related databases;

FIG. 10 is an illustrative information selection screen for the tool for performing administrative functions connected with a sales-related database;

FIG. 11 is an illustrative screen for a broker list for the tool for performing administrative functions connected with a sales-related database;

FIG. 12 is an illustrative broker detail screen for the tool for performing administrative functions connected with a sales-related database;

FIG. 13 is an illustrative broker license information screen for the tool for performing administrative functions connected with a sales-related database;

FIG. 14 is an illustrative broker contact information screen for the tool for performing administrative functions connected with a sales-related database; and

FIG. 15 is an illustrative “rate change” screen for the tool for performing administrative functions connected with a sales-related database.

### DETAILED DESCRIPTION OF THE INVENTION

Reference will now be made in detail to the present preferred embodiments of the invention, examples of which are illustrated in the accompanying drawings in which like reference characters refer to the corresponding elements.

The present invention is described in relation to a system and process for performing administrative functions connected with a sales-related database. Nonetheless, the characteristics and parameters pertaining to the system and process of the invention may be applicable to updating information for other types of databases.

In terms of the general environment and resources in or with which the invention may operate, a computer system may include a bus or other communication mechanism for communicating information and a processor coupled to the bus for processing information. The computer system may also include a main memory such as a random access memory (RAM) or other dynamic storage device, coupled to the bus for storing information and instructions to be executed by the processor. The main memory also may be used for storing one or more temporary variables or other intermediate information during execution of the instructions by the processor. The computer system may further include a read only memory (ROM) or other static storage device coupled to the bus for storing static information and instructions for the processor. A storage device such as a magnetic disk or an optical disk may be provided and coupled to the bus for storing information and instructions.

The computer system may be coupled via the bus to a display, such as a cathode ray tube (CRT), a liquid crystal display (LCD) or other device, for displaying information to a computer system user. An input device, including a plurality of alphanumeric and other keys, is coupled to the bus for communicating information and command selections to the processor. Another type of input device is a cursor control, such as a mouse, a trackball, or cursor direction keys for communicating directional information and command selections to the processor and for controlling cursor movement on the display. This input device typically has two degrees of freedom in two axes, a first axis (e.g., an x axis) and a second axis (e.g., ay axis), that allows the input device to specify a plurality of positions in a plane.

The invention is related to the use of the computer system for updating information in a sales-related database, using a computer, a network and other resources. According to one embodiment of the invention, updating of information in the sales-related database may be conducted via the computer system in response to the processor executing one or more sequences of one or more instructions stored in the main memory.

Such instructions may be read into the main memory from another computer-readable medium, such as the static storage device. Execution of the sequences of instructions stored in the main memory causes the processor to perform the process steps described herein. One or more processors in a multiprocessing arrangement may also be employed to execute the sequences of instructions stored in the main memory. In alternative embodiments, hard-wired circuitry may be used in place of, or in combination with, software instructions to implement the invention. Thus, embodiments of the invention are not limited to any specific combination of hardware circuitry and software.

The term “computer-readable medium” as used herein refers to any medium that participates in providing instructions to the processor for execution. Such a medium may take many forms, including but not limited to, a non-volatile medium, a volatile medium, and a transmission medium. The non-volatile medium may include a dynamic memory, such as the main memory. The transmission medium may include a coaxial cable, a copper wire and a fiber optic network, including the one or more wires that comprise the bus. The transmission medium may also take the form of a plurality of acoustic or light waves, such as those generated during radio frequency (RF) and infrared (IR) data communications. Common forms of computer-readable media include, for example, a floppy disk, a flexible disk, a hard disk, a magnetic tape and any other magnetic medium, a CD-ROM, a DVD, and any other optical medium, one or more punch cards, a paper tape, any other physical medium with patterns of holes, a RAM, a PROM, an electrically-programmable read-only memory (EPROM), a FLASH-EPROM, any other memory chip or a cartridge, a carrier wave as described hereinafter, or any other medium from which a computer can read data stored therein.

Various forms of computer readable media may be involved in executing the one or more sequences of one or more instructions by the processor. For example, the instructions may initially be borne on a magnetic disk of a remote computer. The remote computer can load the instructions into its dynamic memory and can send the instructions over a telephone line using a modem. A modem local to the computer system can receive the data on the telephone line and use an infrared transmitter to convert the data to an infrared signal. An infrared detector coupled to the bus can receive the data carried in the infrared signal and can place the data on the bus. The bus carries the data to the main memory, from which the processor retrieves and executes the instructions. The instructions received by the main memory may optionally be stored on a storage device as described herein, either before or after execution by the processor.

The computer system also includes a communication interface coupled to the bus. The communication interface provides a two-way data communication coupling to a network link that is connected to a local network or other network. For example, the communication interface may be an integrated service digital network (ISDN) card or a modem to provide a data communication connection to a corresponding type of telephone line. As another example, the communication interface may be a local area network (LAN) card to provide a data communication connection to a compatible LAN. Wireless links also may be implemented. In any such implementation, the communication interface sends and receives electrical, electromagnetic or optical signals that carry digital data streams representing various types of information.

The network link typically provides data communication through one or more networks to other data devices. For example, the network link may provide a connection through a local network to a host computer, server or to other data equipment operated by an Internet Service Provider (ISP) or other entity. The ISP in turn provides data communication services through the world wide packet data communication network, now commonly referred to as the “Internet”. The local network and the Internet both use electrical, electromagnetic or optical signals that carry digital data streams. The signals through the various networks and the signals on the network link and through the communication interface, which carry the digital data to and from the computer system, are exemplary forms of carrier waves transporting the information.

The computer system can send messages and receive data, including program code, through the network(s), the network link, and the communication interface. In the Internet example, a server might transmit requested code for an application program through the Internet, an Internet Service Provider (ISP), a local network and the communication interface. In accordance with the invention, one such downloaded application provides for operating and maintaining the system described herein. The received code may be executed by the processor as it is received and/or stored in a storage device, or other non-volatile storage for later execution. In this manner, the computer system may obtain application code via a carrier wave or other communications means.

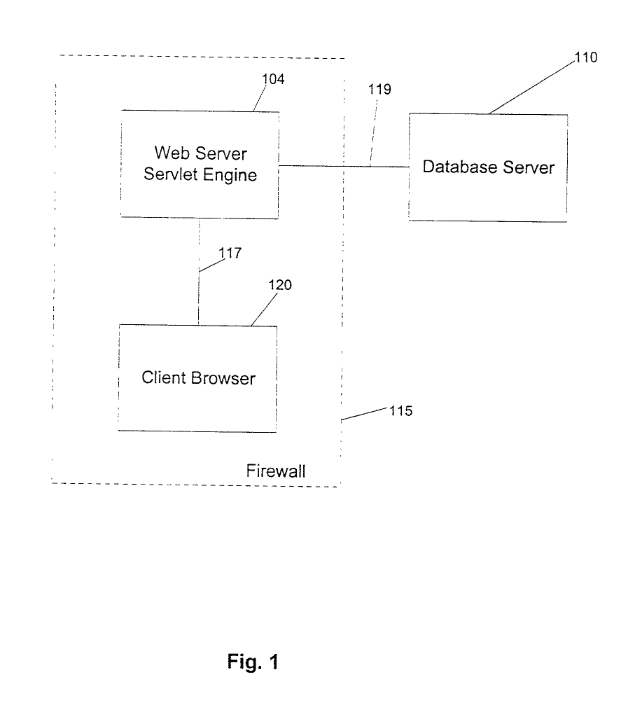

FIG. 1 is a block diagram illustrating one embodiment of a system 100 for updating information connected with a sales-related database. The system 100 includes a web server and a servlet engine 104, a client browser 120, a firewall 115 and a sales-related database which is stored in a database server 110. The web server and the servlet engine 104 are coupled to the client browser 120 through a network link 117 and to the database server 110 through a java database connection (JDBC) 119.

The network link 117 may be comprised of, include or interface to any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34 bis analog modem connection, a cable modem, an Asynchronous Transfer Mode (ATM) connection, a Fiber Distributed Data Interface (FDDI), or Copper Distributed Data Interface (CDDI) connection.

The network link 117 may also be comprised of, include or interface to any one or more of a Wireless Application Protocol (WAP) link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion (RIM) duplex paging type device, a Bluetooth radio link, or an IEEE 802.11-based radio frequency link. The network link 117 may also be comprised of, include or interface to any one or more of an RS-232 serial connection, an IEEE-1394 Firewire connection, a Fibre Channel connection, an infrared (IrDA) port, a Small Computer Systems Interface (SCSI) connection, a Universal Serial Bus (USB) connection or another wired or wireless, digital or analog interface or connection.

An administrative tool residing on the web server and servlet engine 104 may be used by a user using a client browser 120 to upload rate or price change or broker information to the database server 110. The administrative tool may reside on an intranet. The administrative tool may be used by the user to make rate changes whenever a rate change for a product is to be implemented, such as, for example, once a week, once a month, or once a year. The use of the administrative tool allows the rate changes and broker information changes to be effected much more quickly than prior processes allowed.

The client browser 120 may be comprised of or include a personal computer running a Microsoft® Windows95® operating system, a Microsoft® Windows 98® operating system, Millenium™ operating system, a Microsoft® NT™ operating system, a Microsoft® Windows 2000® operating system, a Microsoft® Windows® CE™ operating system, a PalmOS™ operating system, a Unix operating system, a Linux operating system, a Solaris™ operating system, an OS/2™ operating system, a BeOS™ operating system, a MacOS™ operating system or other operating system or platform.

The client browser 120 may include a microprocessor such as an Intel x86-based device, a Motorola 68K device, a PowerPC™ device, a MIPS device, a Hewlett-Packard Precision™ device, a Digital Equipment Corporation Alpha™ RISC processor, a microcontroller or other general or special purpose device operating under programmed control.

The client browser 120 may further include electronic memory such as a random access memory (RAM) or an electrically-programmable read only memory (EPROM), a storage device such as a hard drive, a CDROM, a rewritable CDROM or other magnetic, optical or other media, and other associated components connected over an electronic bus, as will be appreciated by persons skilled in the art. The client browser 120 may also be comprised of or include a network-enabled appliance such as a WebTV™ unit, a radio-enabled Palm™ Pilot or similar unit, a set-top box, a networkable game-playing console such as a Sony Playstation™ or a Sega Dreamcast™, a browser-equipped cellular telephone, or other TCP/IP client or other device. The client browser software may be comprised of or include a Microsoft Internet Explorer™ browser software product or a Netscape Navigator™ browser software product or any other similar browser software product.

The client browser 120 may communicate with the web server and servlet engine 104 through the network link 117 using network-enabled code. The network-enabled code may be comprised of, include or interface to, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS) language, Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compiler language, assembler language, or other computer languages or platforms.

The database server 110 may be comprised of, include or interface to, for example, an Oracle™ relational database application, such as that sold commercially by Oracle Corporation. Other database applications, such as those sold by Informix™, Database 2 (DB2), Sybase or other data storage or query formats, platforms or resources such as On Line Analytical Processing (OLAP), Standard Query Language (SQL), a storage area network (SAN), Microsoft Access™ or other similar database applications may also be used, incorporated or accessed in the invention.

The web server and servlet engine 104 and the client browser 120 may exist inside a firewall 115. The database server 110 may exist behind its own web hosting firewall, to ensure data security.

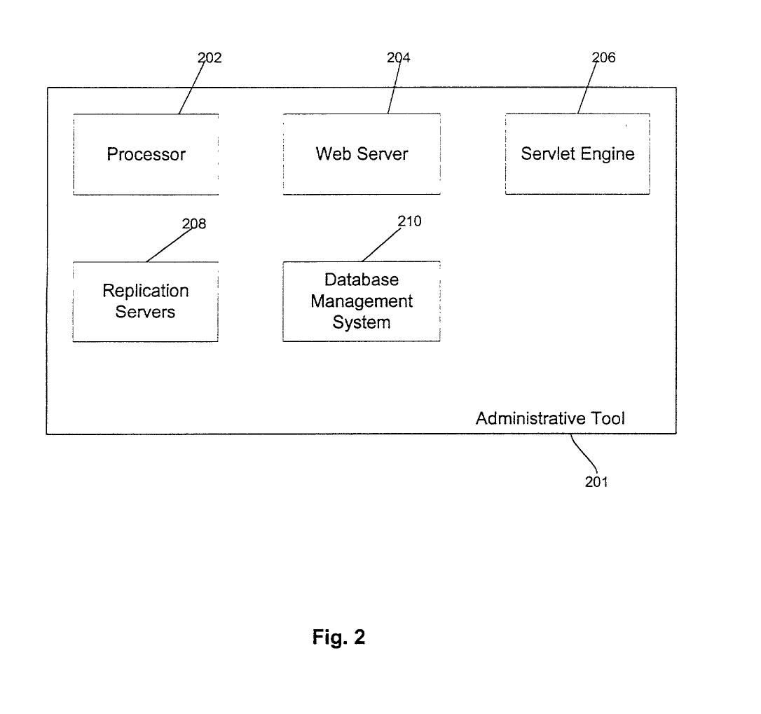

FIG. 2 is a block diagram illustrating one embodiment of an administrative tool 201 for performing administrative functions connected with a sales-related database. The administrative tool 201 includes a processor 202, a web server 204, a servlet engine 206, one or more replication servers 208 and a database management system 210 having at least one sales-related database stored therein.

The client browser 120 of FIG. 1 may access the administrative tool 201 through the web server 204. The administrative tool 201 may be used by the user to perform a plurality of administrative functions such as, for example, updating rates or prices, modifying broker records, or generating reports with respect to data stored in the sales-related database of the database management system 210. The servlet engine 206 may include one or more servlets to run on the web server 204 to perform the administrative functions of the administrative tool 201.

The database management system 210 may include software to access and manage the sales-related database (not shown) and may store a plurality of types of data necessary to perform the functions of the administrative tool 201 such as, for example, login information, broker profiles, rates and other information. The sales-related database or databases managed by the database management system 210 may either be a part of the administrative tool 201 or may reside outside of the administrative tool 201.

The replication servers 208 allow creation and management of duplicate versions of the sales-related database, such as an original production version of a database and a copy of the sales-related database, so that the system administrator user may enter any necessary changes to the data to be stored in the sales-related database(s) to the copy of the sales-related database, which may then be reflected in the production version of the sales-related database.

The processor 202 executes the instructions generated by the web server 204, the servlet engine 206, the replication servers 208, the database management system 210 and any other source(s) of instructions.

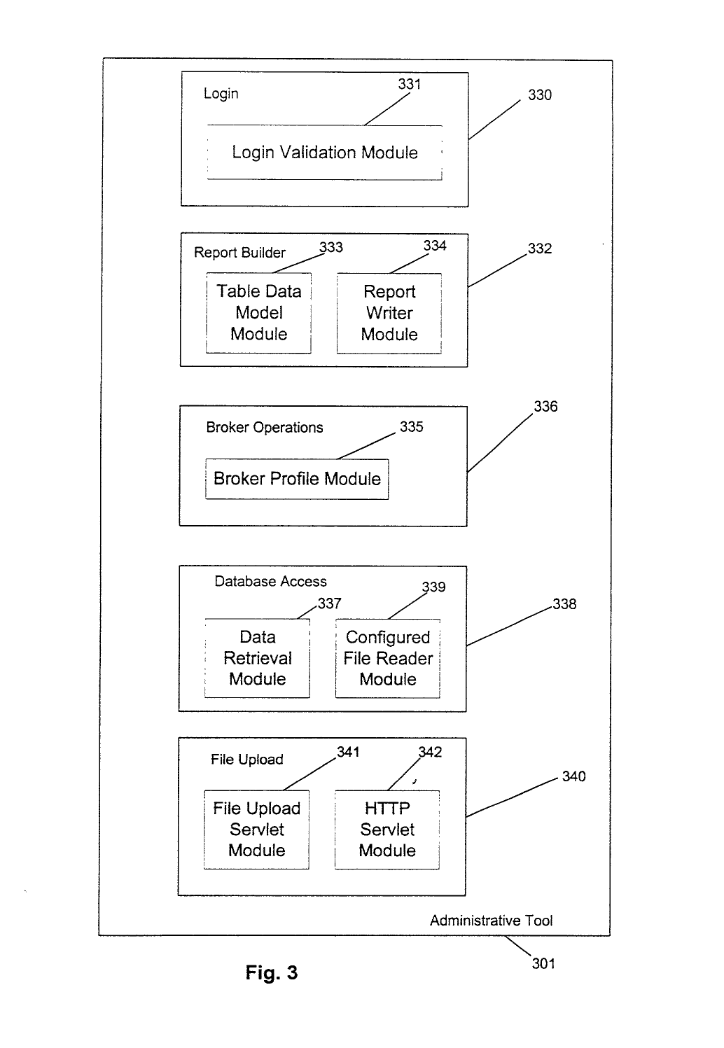

FIG. 3 is a block diagram illustrating one embodiment of an administrative tool 301. The administrative tool 301 includes a login module 330, a report builder module 332, a broker operations module 336, a database access module 338 and a file upload module 340.

The login module 330 includes a login validation module 331. A user may use the login module 330 to login to use the administrative tool 301. The login validation module 331 may validate the user's login by comparing the user's login to previously input login information such as, for example, a user identification and a password, stored in a database storing initial user login information. If the user's login is valid, the login module 330 will allow the user to access the other modules used for performing the functions of the administrative tool 301, including the database access module 338, the file upload module 340, the report builder module 332 and the broker operations module 336.

The report builder module 332 may include a table data model module 333 and a report writer module 334. The table data model module 333 may create or update data tables such as, for example, a visitor tracking table which tracks customer accesses and navigation through the sales-related databases. The report writing module 334 may generate sales reports periodically or may generate reports requested by the user, for example, to present information about other web sites frequently visited by the same customers that access the supplier's sales-related database(s). The table data model module 333 may include a visitor tracking table, a date field and a time field for every sales quote generated pursuant to a customer request and an email ID field recording whether the sales quote information was actually sent to a particular person or entity so that a report may be generated displaying a count for sales quotes requested and a count for actual transactions effected following such sales quotes during a defined period.

The broker operations module 336 may include a broker profile module 335. The broker profile module 335 may be accessed by a supplier's brokers to review one or more broker profiles. Each broker profile may include a URL field so that each broker may be identified with a specific URL. The broker operations module 336 may be accessed by links from different databases.

The database access module 338 may include a data retrieval module 337 and a configured file reader module 339. The data retrieval module 337 may allow retrieval of data from the report builder module 332, the broker operations module 336 and the database server 110. The configured file reader module 339 allows the database access module 338 to read configured files so that a configured file may be uploaded for updating records stored in the sales-related database.

The file upload module 340 may include a file upload servlet module 341 and a HTTP servlet module 342. The HTTP servlet module 342 allows interaction with a web server 204 so that the client system may upload a configured file to the administrative tool 201. The HTTP servlet module 342 may also include form generating means to present client systems with forms in a preconfigured format so that data input by users at a client system and uploaded to the Web server 204 will be in a configured file format that may be read by the configured file reader module 339. The upload servlet module 341 includes a plurality of servlets that allow changes and modifications to be uploaded to the sales-related database for updating data stored therein. The file upload servlet module 341 may include a servlet to allow the upload of a file or may include a multi-part request servlet that allows a multi-part input stream to be transmitted from the Web server 204 to the database server 110.

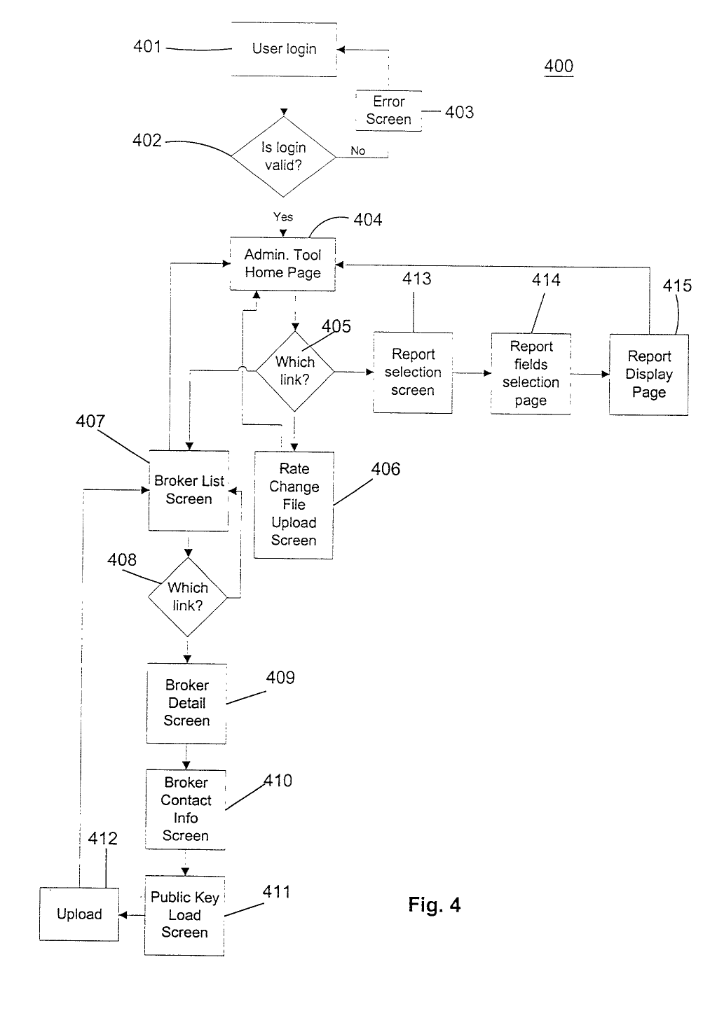

FIG. 4 is a flow diagram illustrating the steps conducted using the administrative tool 301 for performing administrative functions connected with the sales-related database. The process begins at step 401, wherein a user login screen is presented to a user, such as a system administrator. The user may enter login information, such as a login ID and a password, into fields of the user login screen. At step 402, the administrative tool 301 checks to see if the entered login information is valid. If the entered login information is not valid, the administrative tool 301 will present an error screen to the user at step 403. The error screen may include a login section or a link to the login screen 401 or may automatically return the user to the login screen 401.

If the user's login information is valid, the administrative tool 301 will display an administrative tool homepage to the user at step 404. The user may choose a link from the administrative tool homepage and may link to other screens containing information of interest such as a “Broker List” screen, a “Rate Change” screen, or a “Report” screen. At step 405, the administrative tool 301 determines which link the user has chosen. If the user has chosen the “Broker List” screen link, the administrative tool 301 will then display the broker list screen to the user at step 407.

At the broker list screen, the user may choose to use one of the various administrative functions of the administrative tool 301, such as, for example an “add” function, a “modify” function or a “delete” function. The “add” function enables the user to add a new broker listing to the information stored in the sales-related database in the database server 110. The “modify” function enables the user to modify information contained in a particular broker listing stored in the sales-related database. And, the “delete” function enables the user to delete a particular broker listing from a plurality of broker listings stored in the sales-related database in the database server 110. At step 408, the administrative tool 301 may determine which administrative function the user has chosen. If the user chooses to delete a broker listing, the administrative tool 301 may delete a selected broker listing and may then return the user to the broker list screen.

If the user chooses to add or modify a broker listing, the administrative tool 301 displays a broker detail screen to the user at step 409. The user may then update information in one or more fields of the broker detail screen or may update the information through accessing one or more links provided on the broker detail screen. The administrative tool 301 may also display a broker contact information screen at step 410. The user may update broker contact information in one or more fields of the broker contact information screen, or may update the broker contact information through accessing one or more links provided on the broker contact information screen.

At step 411, the administrative tool 301 may display a public key load screen to the user. At the public key load screen, the user may add a new broker key ring filed to a public ring list for encryption purposes. At step 412, the administrative tool 301 may upload the updated information to the sales-related database stored in the database server 110 and may then return the user to the broker list screen and the process will start again at step 407. The user may then choose to add, modify or delete another broker listing.

The step of uploading the updated information to the sales-related database stored in the database server 110 may include a sub-step of uploading a configured file to be read by a configured file reader 339 to update a corresponding record in the sales-related database stored in the database server 110.

The broker list administrative functions performed may further include updating licensing information for each broker listing. When the user has completed modifications to a particular broker listing, the user may choose to return to the administrative tool homepage at step 404.

If the user chooses the “Rate Change” link at the administrative tool homepage of step 404, a rate change file upload screen will be displayed to the user at step 406. The user may enter rate changes into the file upload screen at step 406 and may then upload the file to the sales-related database of the database server 110. The rate change file upload screen may include a rate change screen with a plurality of fields that the user may update. The step of uploading the updated information to the sales-related database of the database server 110 may further include a sub-step of uploading a configured file to be read by the configured file reader 339 to update a corresponding record stored in the sales-related database of the database server 110. The user may then choose to return to the administrative tool homepage at step 404.

If the user chooses the “Report” link at step 404, a report selection screen may be displayed to the user at step 413. The user may choose, at the report selection screen, the type of report the user would like to generate. At step 414, the administrative tool 301 may display a report field selection screen to the user. The user may choose, at the report field selection screen, which fields the user would like to display in the report to be generated.

At step 415, the administrative tool 301 may generate a report display screen. The report display screen may display a table, a chart or other types of reports pertaining to data the user has chosen or data assigned to a particular report. The user may print, download or email the report, depending on the user's wishes and/or the functionality assigned to the particular report type or report writer module by the software or system designer, system administrator or other person having authority to assign functionality. When the user has completed viewing the report display screen, the user may choose to return to the administrative tool homepage at step 404.

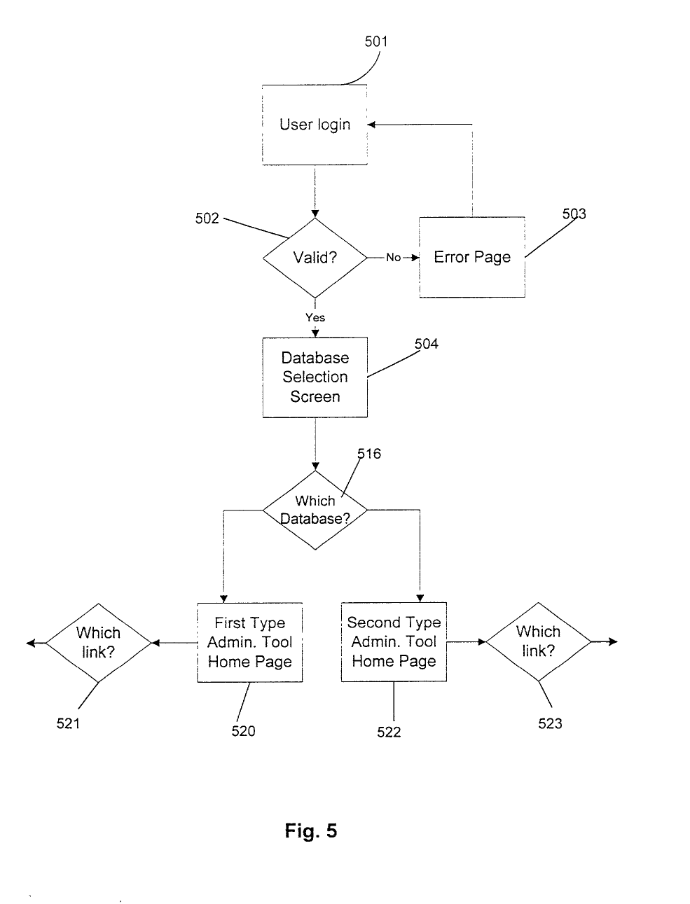

FIG. 5 is a flow diagram illustrating steps performed in a process for performing administrative functions connected with at least two sales-related databases via use of an administrative tool for screen presentation. At step 501, the user is presented with a user login screen and the user must input the user's login information. At step 502, the administrative tool 301 determines if the user's login information is valid. If the user's login information is not valid, an error screen is displayed to the user at step 503 and the user may be returned to the user login screen, as described above with respect to step 403 of the process shown in FIG. 4.

If the user's login information is valid, the administrative tool 301 may present the user with a sales-related database selection screen at step 504. The user may then select the particular sales-related database for which the user must conduct administrative functions. At step 516, the administrative tool 301 determines which sales-related database the user has chosen. If the user has chosen a first sales-related database, the administrative tool 301 will display an administrative tool homepage for the first database at step 520. At step 520, the administrative tool 301 will display, for the first database, a plurality of links for various administrative functions.

At step 521, the administrative tool 301 will determine which link the user has chosen, as described above with reference to step 405 of FIG. 4. The administrative tool 301 will then perform the steps 406-415 of the process described with reference to FIG. 4 above.

If the user chooses a second sales-related database at step 504, the administrative tool will display a second database administrative tool homepage at step 522. The administrative tool 301 will display to the user a plurality of links to various administrative functions such as, for example, a change broker lists function, a rate changes function or a report-to-be-generated function at step 522. The user will then select one of the links. At step 523, the administrative tool 301 will determine which link the user has chosen and will display the appropriate screen as described above with reference to step 405 of FIG. 4. The administrative tool 301 will then display one or more screens to the user based on the link chosen by the user as described above with reference to steps 406-415 of the process of FIG. 4 above.

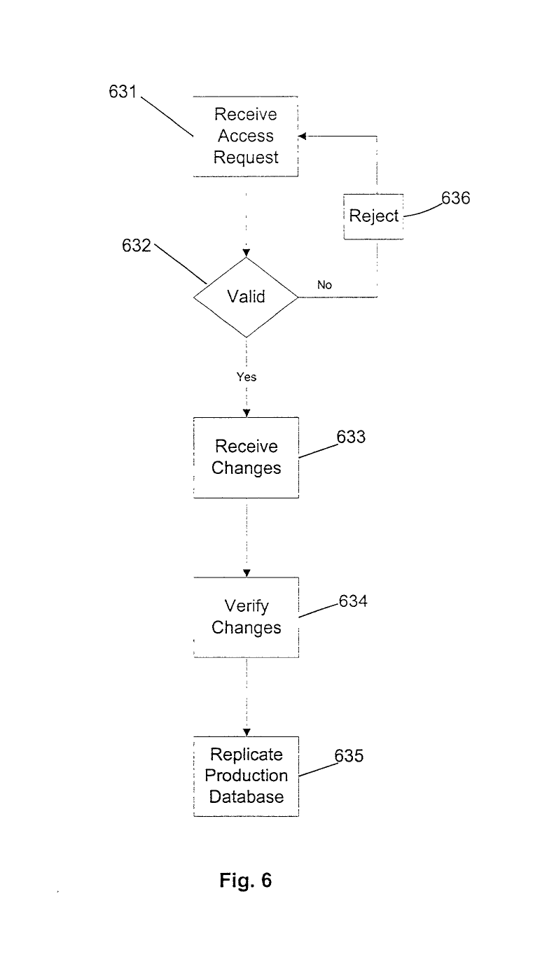

FIG. 6 is a flow diagram illustrating the steps conducted in a process for updating information connected with a sales-related database. At step 631, the administrative tool 301 receives a request from the user to access the administrative tool 301. This request may include an input by the user of a login ID and a password. At step 632, the administrative tool 301 determines whether the user's request for access is valid. If the user's request for access is not valid, the administrative tool 301 may reject the user's request for access to the administrative tool 301 at step 636. The administrative tool 301 may then return the user to step 631 to input another access request.

If the access request received 301 is valid, as determined at step 632, the administrative tool 301 may receive changes to the sales-related database at step 633. The changes to the sales-related database may be received in the form of a file configured to update records stored in the sales-related database. At step 634, the administrative tool 301 may allow verification of any such change. The verification of such changes may be performed by the system administrator or another user designated to verify changes, or by another verification process.

At step 635, the administrative tool 301 will replicate a production version of the sales-related database to update the sales-related information stored in the sales-related database prior to uploading it t the production version of the database which may be accessible to brokers and customers of the supplier via the supplier's Internet site.

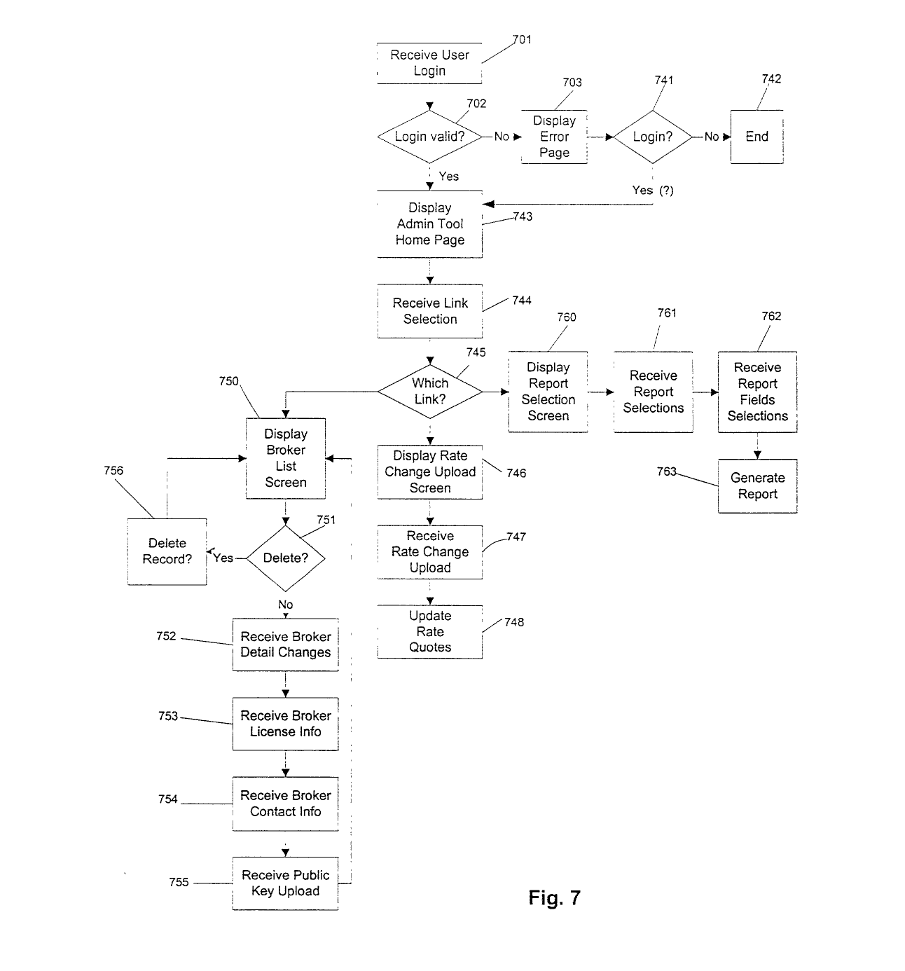

FIG. 7 is a detailed flow diagram illustrating the steps conducted in another embodiment of the process for performing administrative functions connected with a sales-related database. At step 701, the administrative tool 301 receives a user's login information. At step 702, the administrative tool 301 may determine whether the received user login information is valid, as described above with respect to step 402 of the process shown in FIG. 4.

If the login information is not valid, the administrative tool 301 may display an error screen to the user at step 703. If the user wishes to login again, the user may be presented with another login screen, or the error screen displayed at step 703 may include login information fields for the user to pre-input the user's login information. At step 741, the administrative tool 301 may determine whether the user wants to login again. If the user does not want to login again, the administrative tool 301 may end the login process at step 742. If the user does want to login again, the administrative tool 301 may return to step 701 to receive the user's login information again.

If the login information is valid, the administrative tool 301 will display an administrative tool homepage to the user at step 743. The administrative tool homepage may include links to enable the user to perform various administrative functions in connection with the sales-related database, such as making updates to the information contained in broker listings records, making rate changes or generating reports. Each broker listing record may include a field for input of the URL of a referring broker whose site was visited by a customer to obtain a rate quote. A visitor tracking table may then be used to track information specific to each referring broker.

At step 744, the administrative tool 301 may receive a link selection screen, wherein the user may select one of a plurality of links to access one of a plurality of administrative functions. At step 745, the administrative tool 301 may determine which link was selected by the user. If a “display” link is selected by the user, the administrative tool 301 may display a broker list screen 1100 to the user at step 750. The broker list screen 1100 may include links to administrative functions available for the broker listing. At the broker list screen 1100, the user may select a link to enable the user to “delete”, “add” or “modify” a broker listing record.

At step 751, the administrative tool 301 may determine which link the user has selected. If the user has selected the link to delete a broker listing record, the administrative tool 301 may delete the broker listing record at step 756. After deleting the broker listing record, the administrative tool 301 may return to step 750 to display the broker list screen.

If the user selected the “modify” link, the administrative tool 301 may receive changes to be made to the broker listing record at step 752. In one embodiment, the administrative tool 301 may display a broker detail screen 409 including broker detail fields which the user may update by adding or changing information. The user may choose a “submit” button from the broker detail screen 409 to transmit the broker detail changes to the administrative tool 301. The administrative tool 301 may receive the broker detail changes at step 752.

At step 753, the administrative tool 301 may receive broker licensing information input by the user. In one embodiment, for example for use by a supplier in a regulated industry such as the insurance industry, the administrative tool 301 may display a screen listing all states and/or territories in which a broker may be licensed. The listing of states may include check boxes beside each state and/or territory wherein the user may input a check for each state in which the broker is licensed. The user may check one or more or all of the boxes to indicate the state(s) in which the broker is licensed to do business. In one embodiment, the broker license screen may include a check box allowing the user to select all of the states at once or deselect all of the states. The user may choose a “submit” button from the broker license screen to transmit the broker license information changes to the administrative tool 301. The administrative tool 301 may receive the broker license information changes at step 753.

At step 754, the administrative tool 301 receives broker contact information input by the user. In one embodiment, the administrative tool 301 may display a broker contact information screen including a plurality of broker contact information fields which a user may update by adding or changing information. The user may choose a “submit” button from the broker contact information screen to transmit the broker contact information changes to the administrative tool 301. The administrative tool 301 may receive the broker contract information changes at step 754.

At step 755, the administrative tool 301 may receive a public key upload. In one embodiment, the administrative tool 301 may display a public key upload screen including a plurality of fields to allow entry or update of a public key. A public key, used by the administrative tool 301 to encrypt data to be sent to a particular broker, such as information relating to the particular broker's sales and commissions, may be entered on the public key upload screen by the user. The user may choose a “submit” button from the public key upload screen to transmit the public key information to the administrative tool 301. The administrative tool 301 may receive the transmitted public key information at step 755.

In one embodiment, once the information relating to changes to particular broker listing records has been received and uploaded, the administrative tool 301 may return to step 750 to display the broker list screen.

In one embodiment, all of the information stored in the database 110 may be updated in the database server 110 after all of the information has been submitted by the user and the user has signed off from the system. In another embodiment, the sales-related database stored in the database server 110 may be continuously updated as information is input by the user.

If the user chooses to change rates or prices associated with particular products/services offered for sale by the supplier, the administrative tool 301 may display a rate change upload screen at step 746. The rate change upload screen may include a plurality of fields including a list of rates which the user may update. After the user has input the rate change information, the user may choose a “submit” button from the rate change upload screen to transmit the rate change information to the administrative tool 301.

At step 747, the administrative tool 301 may receive the rate change information upload. In one embodiment, administrative tool 301 may update the rates stored in original production version of the sales-related database stored in the database server 110 after the user has signed off from the system.

If the user chooses the link for generating a report at step 744, in one embodiment, the administrative tool 301 may then display a report selection screen at step 760. The report selection screen may include a listing of a plurality of types of reports that may be generated. The user may select one of the report types available and, at step 761, the administrative tool 301 may receive the report selection. The report types may include a visitor tracking report, a quotes actually requested report, a report listing transactions effectuated during a particular time period, an e-mail information report, or a broker status report.

In one embodiment, the administrative tool 301 may display a “report field selection” screen. The “report field selection” screen may include a list of fields available for the user to select for inclusion in the report to be generated. In one embodiment, the report field selection screen may be a part of the report selection screen. At step 762, the administrative tool 301 may receive the input report fields selected by the user. At step 763, the administrative tool 301 may generate the report selected.

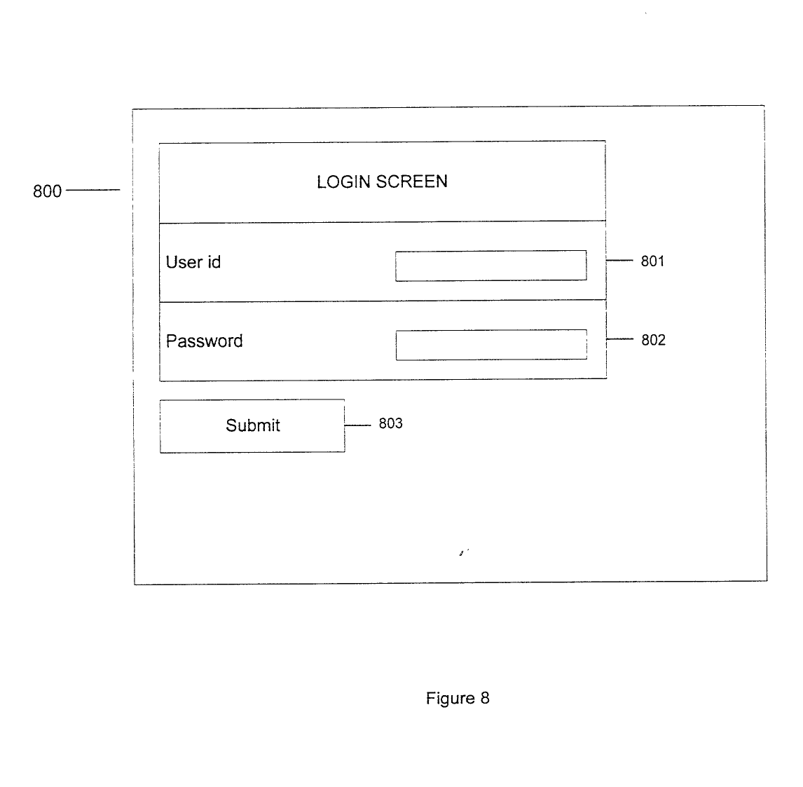

FIG. 8 is an illustrative login screen 800 for the administrative tool 301. The login screen 800 is the first screen displayed to the user when using the administrative tool 301. The user may input a user ID in field 801 and a password in field 802. If the input user ID and password are correct, the user will be directed to a next screen. However, if the input user ID and password are incorrect, the user may be directed to an error screen.

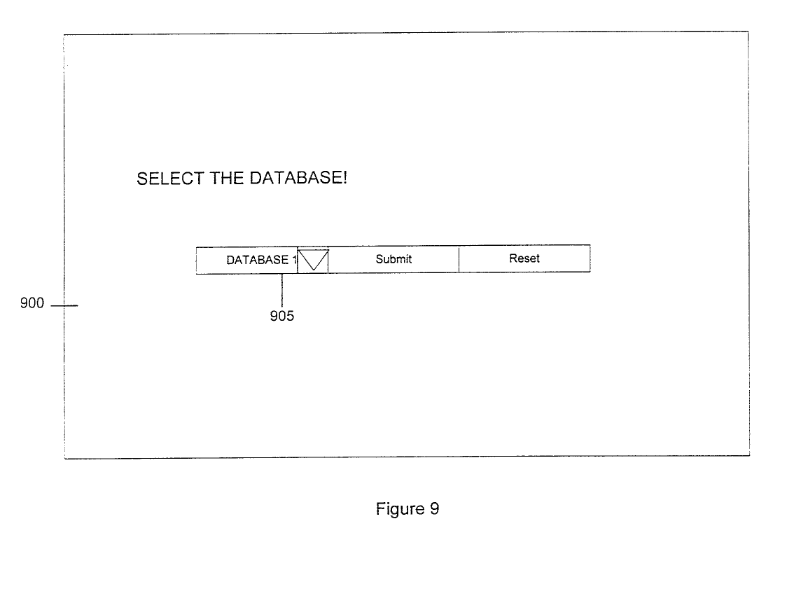

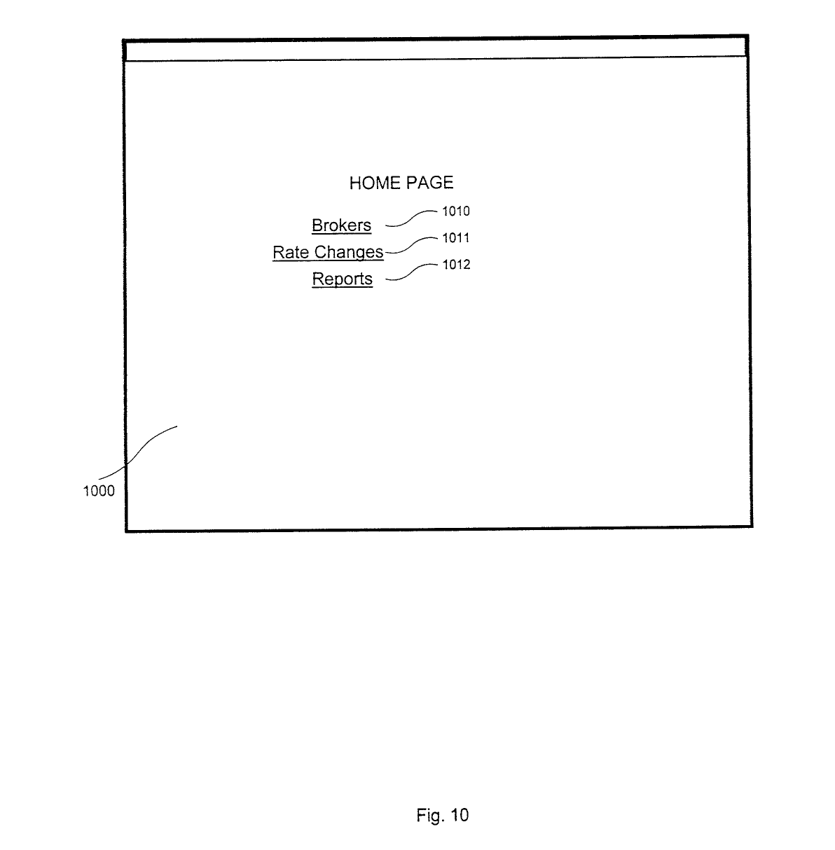

FIG. 9 is an illustrative database selection screen 900 for the administrative tool 301. The database selection screen 900 may include links to available databases. As shown in FIG. 9, a drop down menu 905 may be used to list available databases. For example, for an insurance supplier, there may be a database relating to a “Term Life” insurance product, such as that illustrated. The user may select a particular database from the database selection screen 900. In one embodiment, selection of a database may take the user to the homepage of the selected database, as described below with reference to FIG. 10.

FIG. 10 is an illustrative administrative tool homepage 1000 for use in performing administrative functions for a sales-related database for an insurer's term life insurance products, such as that illustrated. The homepage 1000 may include a plurality of links to a broker functions section 1010, a rate change functions section 1011, and a reporting functions section 1012. The user may select one of the links and be transported to screens for use in performing the selected function.

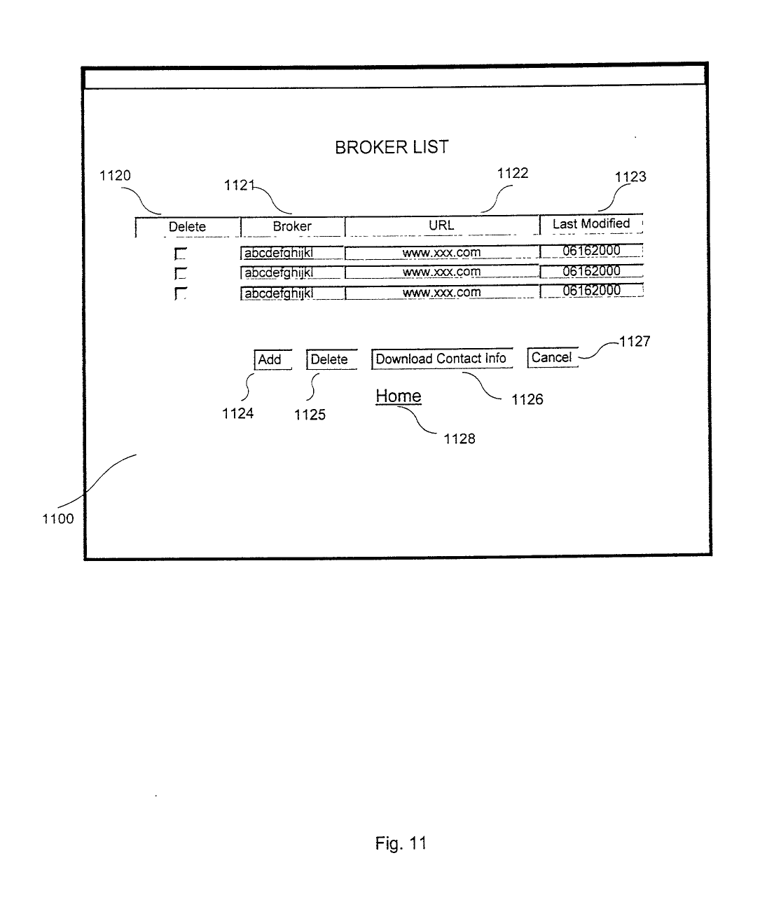

FIG. 11 is an illustrative brokers' listing screen 1100 for the administrative tool 301. The brokers' listing screen 1100 may include a plurality of fields such as a broker name field 1121, a URL field 1122, and a last modified date field 1123. The brokers' listing screen 1100 may also include a plurality of boxes to allow the user to delete a broker record 1120 by checking a box corresponding to the broker record 1120 to be deleted. The brokers' listing screen 1100 may also include a plurality of buttons 1124-1127 to provide the user with links to screens for performing a plurality of administrative functions including an “Add” function 1124, a “Delete” function 1125, a “Download Contact Information” function 1126 and a “Cancel” function 1127. The brokers' listing screen 1100 may list all of the brokers who are authorized or licensed to sell particular products/services of the supplier. The brokers' listing screen 1100 may further include a link 1128 to the homepage 1000.

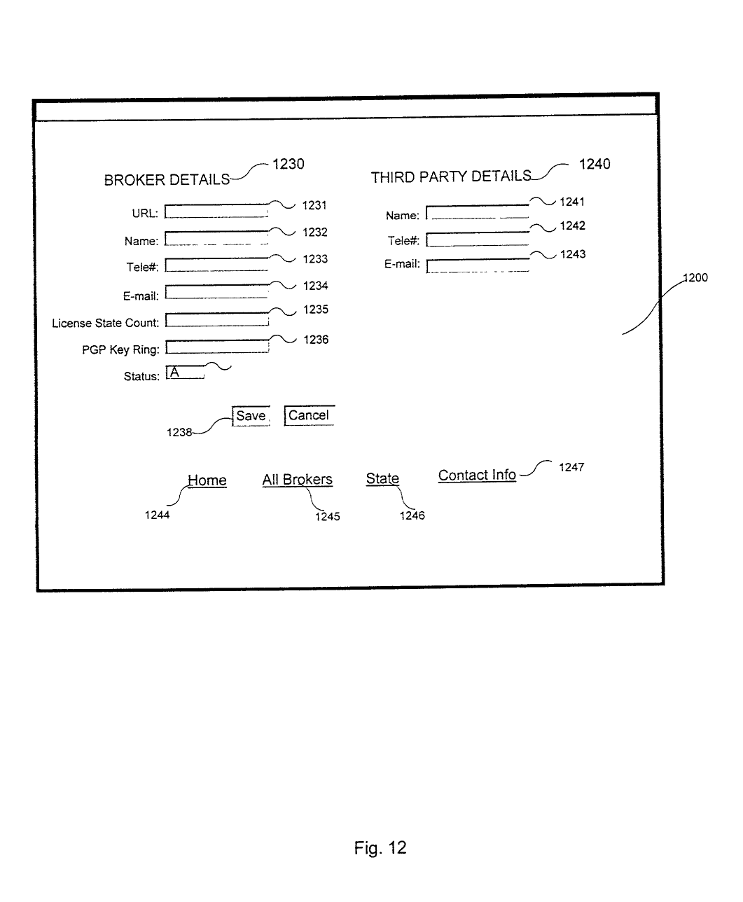

A new broker may be added to the brokers' listing screen 1100 using the add button 1124. In one embodiment, when the user clicks on the add button 1124, the user may be taken to a broker detail screen as described with reference to FIG. 12 below. The user may then use the brokers listing screen 1100 to input information related to particular brokers.

One or more brokers may be removed from the brokers' listing screen 1100 by selecting the corresponding checkbox function 1120 and by selecting the delete button 1125. The administrative tool 301 may be configured so that a confirmation message box appears before the deletion is completed. A broker may not be deleted from the brokers' listing screen 1100 if the broker is still listed in a broker_state table or if the broker's contact information is not deleted from the brokers' listing screen 1100.

The broker name in field 1121 may be a hyperlink to take the user to a broker detail screen. The broker detail screen, when accessed through a broker name hyperlink in field 1121, may include a plurality of fields for input of, or modification of, broker information.

The broker detail screen for a particular broker may include a plurality of fields for information concerning the particular broker including a broker URL, a broker name, a broker telephone number, a broker e-mail address, a broker second telephone number, a broker second e-mail address, a license flag, and a license count.

Since a broker may be authorized to do business in several states, another record stored in the database server 110 may include a broker_state table, which may include a list of states where a particular broker is authorized to do business. Before deleting a broker from the broker listing record, the user must first delete the information about the broker for each state in which the broker was authorized to conduct business. In order to do this, the user may be guided to a state_list page to delete the information for each state in which the broker is licensed. Then, the broker may be deleted from the broker listing record.

A license flag field and a license count field are read-only fields available for information. The license flag field is set to “true” when the broker license count reaches 51, i.e., when the broker is authorized in all states of the United States. The license count is updated by a trigger written in the broker_state table.

FIG. 12 is an illustrative broker detail screen 1200. The broker detail screen 1200 may include various broker detail fields 1230 to input or modify broker or third party information. The broker detail screen 1200 may also include a plurality of hyperlinks linking the broker detail screen 1200 to a homepage 1244, a brokers' list 1245, a broker state list 1246 and a broker contact information screen 1247.

The broker detail fields 1230 may include a broker URL field 1231, a broker name field 1232, a broker telephone number field 1233, a broker e-mail field 1234, a broker license state count field 1235, a broker public key ring field 1236 and a broker status field 1237. A plurality of third party details fields 1240 may also be included in the broker detail screen 1200, which may include a third party name field 1241, a third party telephone number field 1242, and a third party e-mail address field 1243.

The broker detail screen 1200 may be reached either through the add button 1124 of the brokers' list screen 1100 or through the broker name hyperlink 1121 of brokers' list screen 1100. If the broker detail screen 1200 is accessed through the add button 1124, the user may input information concerning a particular broker. Information entered on the broker detail screen 1200 may be saved by selecting the save button 1238. When the user opens the broker detail screen 1200, information concerning a particular broker is retrieved from the database in the database server 110 and is used to populate the fields of the broker detail screen 1200.

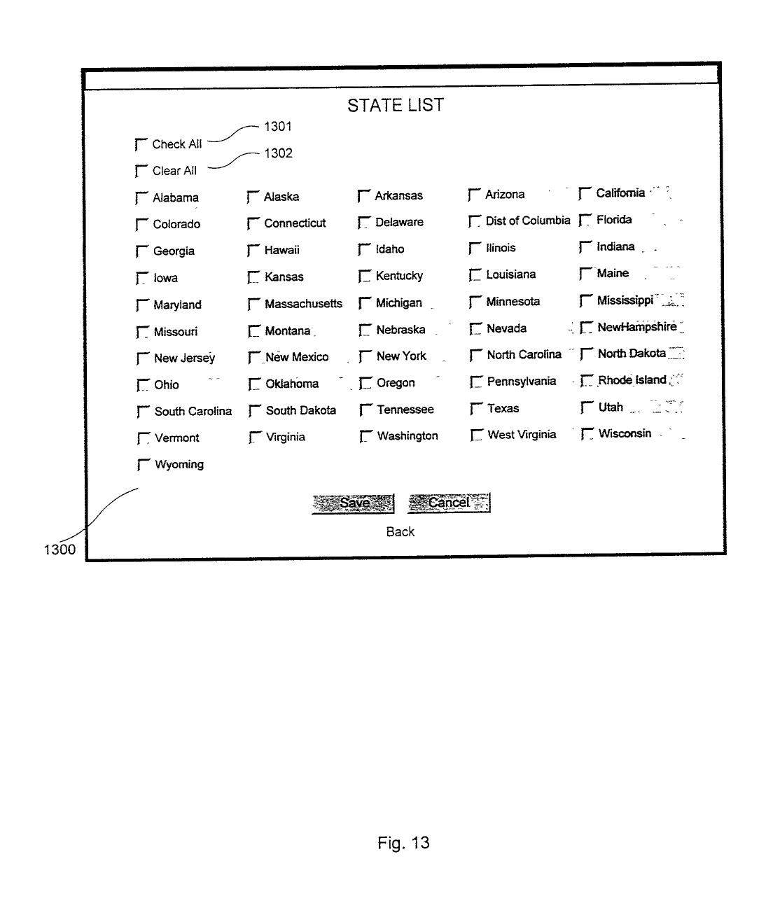

FIG. 13 is an illustrative state list 1300 for a broker record. The state list 1300 may be accessed through the “state” hyperlink 1246 on the broker detail screen 1200. The user may select states in which a broker is licensed to do business, either one at a time by checking each the box next to each authorized state, or all at once by selecting the “check all” box 1301. The user may also deselect all of the states in the state list for a broker by checking the “clear all” box 1302. Upon saving, the states checked will be associated with a particular broker and the particular broker's broker record.

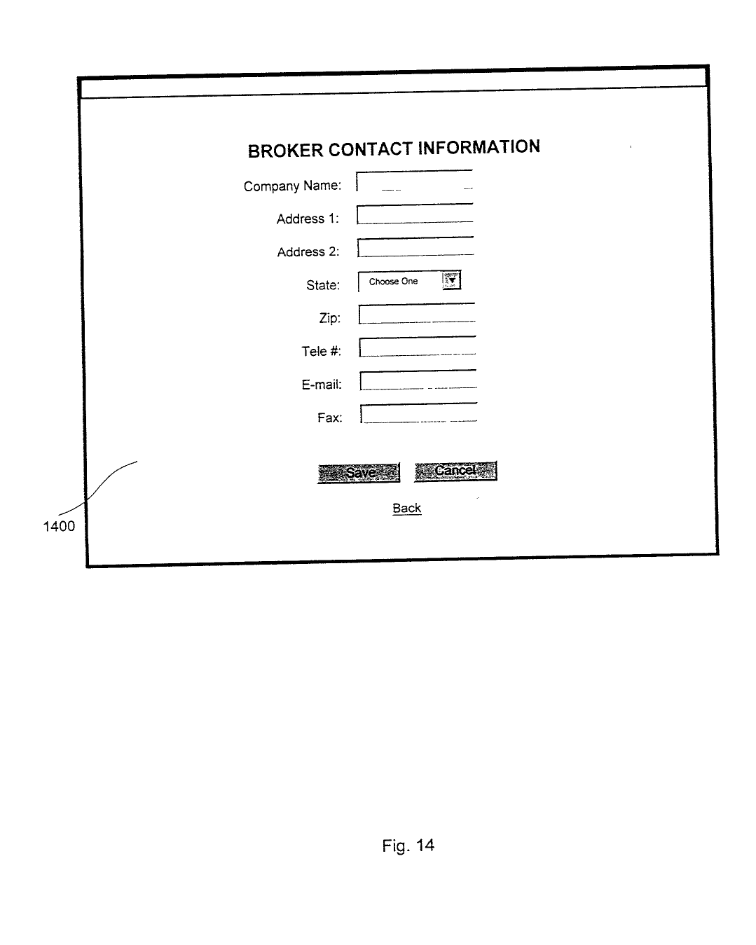

FIG. 14 is an illustrative broker contact information screen 1400 of a broker record. The broker contact information screen 1400 may be accessed by choosing the “contact information” hyperlink 1247 on the broker detail screen 1200. The broker contact information may include information indicating where the system administrator user may reach a particular broker for administrative purposes.

In one embodiment, when the download contact information button 1126 on the broker list screen 1100 is selected, the contact information in the fields of the broker contact information screen 1400 may be downloaded into an application such as, for example, a Word document or an Excel spreadsheet. The broker contact information may then be used to generate sales reports, for example.

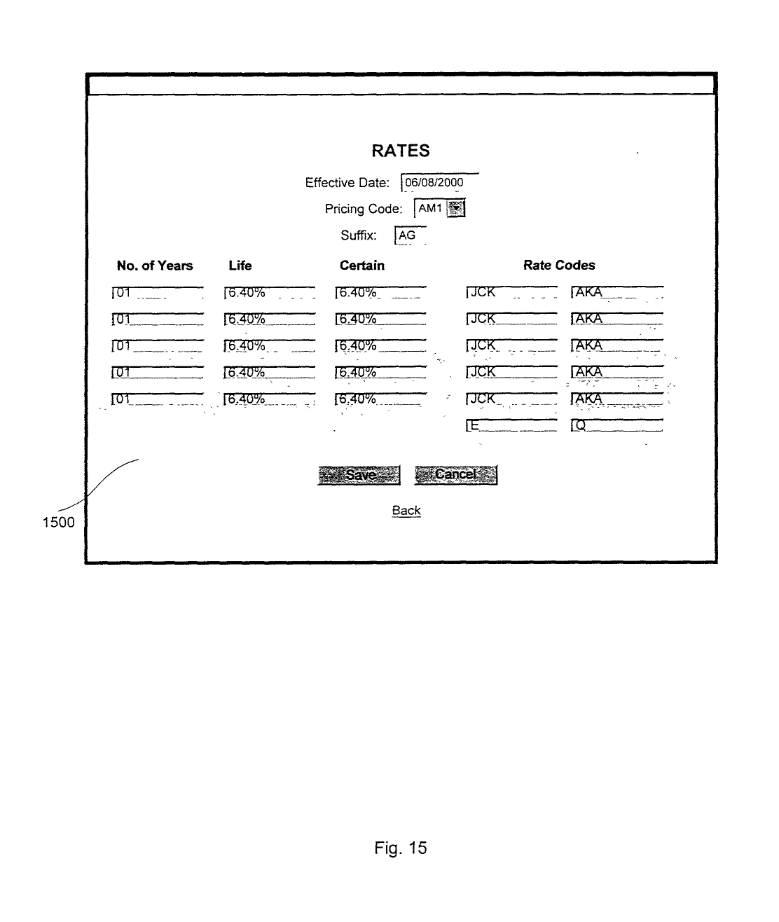

FIG. 15 is an illustrative rate change screen 1500 for the administrative tool 301. The rate change screen 1500 may be used by an information technology department to create scripts to feed a plurality of tables in the sales-related database stored in the database server 110. The tables may include a payout rate table and a rate pricing table, for example. The values of the rate page may be used to calculate premiums for an insurance policy for an insurance supplier, for example. The rate quotes generated for the insurance supplier in the illustrative screen display may depend on the number of years selected and the type of insurance product selected.

The user may access the rate change screen 1500 of the administrative tool 301 by clicking on a rate change link 1011 of the database homepage 1000. The administrative tool 301 may be configured so that a dialog box will pop up asking the user to select a file corresponding to a product or service for which a rate change will be input and then uploaded to a production version of the sales-related database. Upon selection of the appropriate file, the file will be uploaded to the production version of the sales-related database. The production version of the sales-related database will then contain the updated rate change information.

The administrative tool 301 may be configured so that once a status is updated for a particular broker on the broker detail screen 1200, if the updated status is approved, an e-mail message should be generated with the updated broker details and sent to the particular broker. If a broker URL is updated, or a URL is added in the case of a new broker, an HTML page may be generated. The contents of the HTML page generated may be static except where the broker URL needs to be dynamically inserted. This file, including the HTML page with updated broker URL, may be sent to the broker as an attachment to the email message.

As is apparent, among other results, the use of the administrative tool for performing various administrative functions connected with sales-related databases facilitates the system administrator's ability to implement changes to the information stored in such sales-related databases in a more timely and cost-efficient manner, thereby ensuring that sales reports generated therefrom contain current, accurate information.

While the foregoing description includes details and specificities, it should be understood that these have been included for purposes of explanation only, and are not to be interpreted as limitations of the present invention. Modifications to the embodiments described above can be made without departing from the spirit and scope of the invention, as is intended to be encompassed by the following claims and their legal equivalents.

What is claimed is:

1. A process for performing administrative functions connected with a sales-related database comprising the steps of:
receiving updated information for the sales-related database in a file configured in a predetermined format;
saving the configured file containing the updated information to the sales-related database; and
uploading the sales-related database to a web-based database using an administrative tool.

2. A system for performing administrative functions connected with a sales-related database comprising:
means for receiving updated information for the sales-related database in a file configured in a predetermined format;
means for saving the configured file containing the updated information to the sales-related database; and
means for uploading the sales-related database to a web-based database using an administrative tool.

3. The system of claim 2 wherein the administrative tool comprises means for transmitting a file to update information in the sales-related database.

4. A system for performing administrative functions connected with a sales-related database comprising:
a user login module for restricting access to the system;
a database access module for accessing data stored in the sales-related database and for reading one or more configured files; and
a file upload module for uploading data to the sales-related database and the system.

5. The system of claim 4 further comprising a report building module for presenting data in one or more predetermined formats and for generating one or more reports.

6. The system of claim 4 further comprising a broker operations module for updating broker information in the sales-related database.

7. The system of claim 4 wherein the file upload module further comprises a form generator to generate preconfigured forms for receiving one or more information updates.

8. The system of claim 7 wherein the file upload module further comprises a file upload servlet module for transmitting the information updates received in a preconfigured format to the database access module to be read as a configured file and to update the data stored in the sales-related database.

9. A process for performing administrative functions connected with a sales-related database comprising the steps of:
receiving login information from a client system;
determining if the login information is valid;
transmitting an administrative functions home page to the client system if the login information is valid;
receiving a function link selection from the client system;
determining which function link was selected;
displaying an administrative function screen corresponding to the function link selected;
receiving updated information in a predetermined format; and
updating the sales-related database to store the received updated information.

10. The process of claim 9 wherein the step of displaying an administrative function screen comprises displaying a broker list screen if a broker list update function is selected.

11. The process of claim 10 further comprising the steps of:
receiving a broker administrative function link selection;
determining which broker administrative function link was selected;
deleting a selected broker if a delete link was selected; and
displaying at least one broker information screen if a delete link was not selected wherein the step of receiving updated information includes a sub-step of receiving updated information entered in the at least one broker information screen.

12. The process of claim 11 wherein the at least one broker information screen includes at least one of a broker detail screen, a broker contact information screen and a broker public key loading screen.

13. The process of claim 9 wherein the step of displaying an administrative function screen includes a sub-step of displaying a rate change screen if a rate change function is selected.

14. The process of claim 13 wherein the step of receiving updated information includes a sub-step of receiving updated information entered in the rate change screen.

15. The process of claim 9 wherein the step of displaying an administrative function screen includes a sub-step of displaying a report screen if a report function is selected.

16. The process of claim 15 further comprising the steps of:
receiving report type selection information;
receiving report fields selection information; and
generating a report.

17. The process of claim 16 wherein the report type selection information comprises at least one of visitor tracking, quotes actually requested, actual deals made during a time period, e-mail information, and broker status sheet.

18. The process of claim 9 further comprising the steps of:
receiving a quote engine link selection; and
determining which quote engine link selection was received;
wherein the step of transmitting the administrative functions home page comprises transmitting a first type database administrative functions home page if a first database selection was received, and transmitting a second type database administrative functions home page if a second type database selection was received.

19. A system of performing administrative functions connected with a sales-related database comprising:
means for receiving login information from a client system;
means for determining if the login information is valid;
means for transmitting an administrative functions home page to the client system if the login information is valid;
means for receiving a function link selection from the client system;
means for determining which function link was selected;
means for displaying an administrative function screen corresponding to the function link selected;
means for receiving updated information in a predetermined format; and
means for updating the sales-related database to store the updated information.

20. A process for updating information in a sales-related database comprising the steps of:
receiving an access request;
determining if the access request is valid;
receiving updated information if the access request is valid;
verifying the received updated information; and
replicating the sales-related database.

21. The process of claim 20 wherein the step of verifying the received updated information includes a sub-step of updating the received updated information in an administrative area.

22. A computer readable medium, the computer readable medium storing computer readable code executable to perform a process for integrating one or more updates into a sales-related database over a network, wherein the integrating process comprises the steps of:
receiving updated information for the sales-related database in a file configured in a predetermined format;
saving the configured file containing the updated information to the sales-related database; and
uploading the sales-related database to a web-based database using an administrative tool.

23. A computer readable medium, the computer readable medium storing computer readable code executable to perform a process for integrating one or more updates into a sales-related database over a network, wherein the integrating process comprises the steps of:
receiving login information from a client system;
determining if the login information is valid;
transmitting an administrative functions home page to the client system if the login information is valid;
receiving a function link selection from the client system;
determining which function link was selected;
displaying an administrative function screen corresponding to the function link selected;
receiving updated information in a predetermined format; and
updating the sales-related database to store the received updated information.

24. A computer readable medium, the computer readable medium storing computer readable code executable to perform a process for integrating one or more updates into a sales-related database over a network, wherein the integrating process comprises the steps of:
receiving an access request;
determining if the access request is valid;
receiving updated information if the access request is valid;
verifying the received updated information; and
replicating the sales-related database.
